(19) United States
(12) Patent Application Publication
(10) Pub. No.: US 2012/0092183 A1
(43) Pub. Date: Apr. 19, 2012

(54) Emergency Lighting System with Projected Directional Indication

(76) Inventors: Brian A. Corbett, Middletown, DE (US); Adam Lilien, Syracuse, NY (US)

(21) Appl. No.: 13/088,322

(22) Filed: Apr. 15, 2011

Related U.S. Application Data
(60) Provisional application No. 61/324,745, filed on Apr. 15, 2010.

(51) Int. Cl. G08B 5/00

(52) U.S. Cl. 340/815.4

(57) ABSTRACT

An emergency lighting device for providing a directional indication on a recipient surface with first and second guidance indication light sources retained relative to a housing to emit beams of light, each with a directional indication, onto a recipient surface. The light sources can be individually operable and can have directional indications, such as arrows, pointing in first and second different directions. An illumination light source without a guidance indication can illuminate an adjacent area. Guidance indication light sources, which can be lasers, can emit beams in different colors to provide threat level indications. Plural emergency lighting devices can cooperate to guide a building occupant by providing directional indications on recipient surfaces.

### FIELD OF THE INVENTION

The present invention relates generally to lighting devices. More particularly, disclosed herein are emergency lights and emergency lighting systems wherein the activation of the system triggers a projected directional indication by the emergency light onto a recipient surface, such as a floor, to guide building occupants, including during emergency, evacuation, or other predetermined conditions, events, or other guidance situations.

### BACKGROUND OF THE INVENTION

Audible and visual alarms activated by emergency alarm systems provide an indication of a potential emergency situation to building occupants. In an emergency situation where power to the building is terminated, emergency lights can be automatically actuated in response to the loss in electrical power. Emergency alarm systems seek to enable building occupants to react appropriately, such as by seeking safe egress or attempting to remedy the emergency situation.

Emergency lights are commonly located in rooms and hallways either adjacent to or in direct relation to the ceiling. In an emergency situation, such as in the event of a fire, smoke accumulates in the rooms and hallways of the building. The smoke tends to rise toward the ceiling thereby potentially blocking out the emergency lights and hindering safe egress. The resulting combination of darkness and smoke can disorient and panic an occupant thereby making escape still more difficult.

An occupant familiar with a given building may have knowledge of an escape route but may nonetheless find escape difficult in smoky darkness. Furthermore, research indicates that occupants, particular unfamiliar occupants, often seek to take the same path during an emergency evacuation that he or she took upon entering the building. The unfamiliar occupant begins with little or no knowledge of an alternate escape route and then is further prejudiced by the feeling of panic that often accompanies such events in combination with the visual obstructions presented by the emergency situation.

Consequently, a person seeking to evacuate from a smoke-filled environment with limited illumination, which may be severely blocked by smoke, or nonexistent emergency lighting, such as when the building's AC power remains on thereby preventing emergency lights from activating, can become disoriented, unable to reach building exits, and at risk of injury or even death due to the lack of awareness of a safe exit or as a result of unseen hazards. Knowing this, fire prevention professionals commonly educate building occupants to crawl on the floor to the nearest exit so that they travel below the smoke column. Likewise, it is common for firefighters to crawl into a working fire with a flashlight in hand attempting to see their way, even when lights illuminated above the smoke are attempting to shine down from the ceiling. Indeed, the building community has acknowledged these challenges of locating an egress path during an emergency by updating building codes in many jurisdictions to require the placement of “EXIT” signage within 18 inches of the floor on egress access doors to stairways.

A solution to certain deficiencies exhibited by the prior art was disclosed by an inventor of the present emergency lighting system in U.S. Pat. No. 7,220,010, which is incorporated herein by reference. There, an emergency light for providing illumination during emergency conditions is shown and described wherein a light source is axially extended from a retracted position in response to a sensed emergency condition.

The prior art has also disclosed illuminated indicator covers for guiding egress, such as the translucent covers included on “EXIT” and similar signs. Illuminated Exit signs commonly include chevron or arrow-shaped panels to indicate the direction of escape. For example, in U.S. Pat. No. 5,611,163, a cover for an emergency lighting device provides an illuminated direction indicator.

However, as discussed above, the safest escape from a smoke-filled building is by way of the floor based on the tendency of smoke to rise. With such emergency lights and exit signs normally located toward the ceilings of the respective room or hallway, the light from the illuminated sign is rendered nearly useless. The occupant trying to escape will be unable to see the signs and unable to find the path of escape.

U.S. patent application No. 2008/0266065 discloses an emergency evacuation system that emits a pair of dissimilarly colored laser beams that are generated substantially parallel to hallways of a structure and subsequently reflected, where required, to direct occupants to a shortest exit route in the event of an emergency. A first laser beam of a first color is generated substantially parallel to one side or a hallway while a second laser beam of a second color different from the first color is generated substantially parallel to the opposite side of the hallway. The laser beams can project down a hallway to reach a mirror that then reflects the beam down a second hallway and so on. The apparent premise is that the occupant will be directed to the closest exit in the event of a fire emergency so long as an occupant of the structure positions himself or herself between the two laser beams and keeps the laser beam of the first color on his or her right hand side.

Unfortunately, building occupants may not be aware of the operation of such arrangements or might not keep the first color on the right side for some other reason. Furthermore, any blocking of the emitting device will interrupt the path of the beam thereby rendering the system useless. Still further, if the environment is filled with smoke, the occupant will likely be crawling on the floor where the laser may be difficult to see. An occupant will be forced to look up causing the occupant to lift his or her head to be exposed to smoke. The differently colored beams and the operation of the device can be confusing to an already disoriented occupant trying to escape a dangerous emergency situation.

With a knowledge of the foregoing, the present inventors have appreciated that the operation of emergency lights and emergency lighting systems would be improved by an emergency lighting system that provides clear, readily understood directional indication in the event of an emergency or other predetermined activation condition below the likely levels of smoke and other potential obstructions. The inventors have further understood that projecting guidance information onto a floor or other recipient surface can assist in safe and effective egress or other travel by building occupants during predetermined activation conditions.

### SUMMARY OF THE INVENTION

The present invention is thus founded on the basic object of providing an emergency lighting system and method for projecting directional indications during an emergency or other predetermined activation condition.

A related object of the invention is to provide an emergency lighting system and method that projects directional guidance indications effectively even in a smoke-filled environment.

In certain embodiments of the invention, another related object is to provide an emergency lighting system and method that projects directional guidance indications in the form of arrows, lines, or other indications in fixed or transient indication patterns.

A further object of the invention is to provide an emergency lighting system and method for projecting an evacuation path for facilitating safe and effective egress from a building.

Another object of embodiments of the invention is to provide an emergency lighting system and method employing LED and, additionally or alternatively, laser or other light beams to project informational text and or graphics.

Further objects of embodiments of the invention include providing an emergency lighting system and method that provides network topology with unique ID and Group ID addressable and monitoring capabilities.

Yet another object of the invention in certain embodiments is to provide an emergency lighting system and method with input and output circuitry components enabling self-diagnostic reporting capabilities and real-time status feedback during multiple operating conditions.

An even further object of embodiments of the invention is to provide an emergency lighting system and method that can be powered by AC or DC current, by internal rechargeable battery, or through remote power sources, such as a generator, inverter, or central battery unit.

An additional object of the invention in certain embodiments is to provide an emergency lighting system and method that can be fully-recessed and mounted flush in a wall or ceiling, preferably in a wall with close proximity to the floor, to provide bright and clear directional guidance below smoke and other potential obstructions.

Another object of the invention is to provide an emergency system and method including a cover plate that is paintable or configurable to match the decor of a given building, wall, or ceiling.

A further object of particular embodiments of the invention is to provide an emergency lighting system and method with lamps having potentially variable wattage, such as LED, halogen, xenon, or incandescent lights, to provide bright illumination with fixed or moveable lenses.

An even further object of the manifestations of the invention is to provide an emergency lighting system and method with lamps that can incorporate multiple colors or other means for indicating current and potential future readiness or alert conditions.

An even further object of embodiments of the invention is to provide an emergency lighting system and method with audible annunciation capabilities, video capabilities with input and output means, topology capabilities, and panic button mechanisms whereby two-way communications with the building security personnel can be realized.

Still another object of the invention in particular constructions is to provide an emergency lighting system and method with means for enabling the location and actuation of sensing devices where chemical, biological, and radiological conditions are detected, and the signals of such incidents are communicated to the building management system.

These and further objects and advantages of the invention will become obvious not only to one who reviews the present specification and drawings but also to one who has an opportunity to make use of an embodiment of the instant invention for an emergency lighting system and method with projected directional indication. However, it will be appreciated that, although the accomplishment of each of the foregoing objects in a single embodiment of the invention may be possible and indeed preferred, not all embodiments will seek or need to accomplish each and every potential object and advantage. Nonetheless, all such embodiments should be considered within the scope of the present invention.

One will appreciate that the foregoing discussion broadly outlines the more important features of the invention to enable a better understanding of the detailed description that follows and to instill a better appreciation of the inventors' contributions to the art. Before any particular embodiment or aspect thereof is explained in detail, it must be made clear that the following details of construction, descriptions of hardware and software designs, and illustrations of inventive concepts are mere examples of the many possible manifestations of the invention.

### BRIEF DESCRIPTION OF THE DRAWINGS

Various other objects, features, and attendant advantages of the present invention may become apparent in view of the detailed description that follows and the accompanying drawings, in which like reference characters designate the same or similar parts throughout the several views, and wherein:

FIG. 1 is an exploded perspective view of an emergency lighting device with projected directional indication according to the present invention;

FIG. 2 is an alternative, partially exploded perspective view of the emergency lighting device with projected directional indication of FIG. 1;

FIG. 3 is an assembled perspective view of the emergency lighting system with projected directional indication of FIG. 1;

FIG. 4 is a top plan view of a projected directional indication from a plurality of emergency lighting devices as disclosed herein providing guidance in relation to a building structure;

FIGS. 5 and 6 are front and rear elevational views of an emergency lighting device as disclosed herein;

FIG. 7 is a sectioned view in side elevation of the emergency lighting system of FIG. 1;

FIG. 8 is a partially disassembled rearward perspective view of the emergency lighting system of FIG. 1;

FIG. 9 is a perspective view of an emergency lighting device under the present invention as mounted into a wall surface;

FIG. 10 is a schematic view of an emergency light system as disclosed herein;

FIG. 11 is a view in front elevation of an alternative emergency lighting device according to the invention;

FIG. 12 is a partially sectioned view in side elevation of the emergency lighting device of FIG. 11;

FIG. 13 is a partially sectioned, schematic view in rear elevation of the emergency lighting device of FIG. 11;

FIG. 14 is a sectioned view in side elevation of a projecting light source according to the invention;

FIG. 15 is a perspective view of a plurality of lighting devices as disclosed herein; and

FIG. 16 is an alternative perspective view of the lighting devices of FIG. 15.

### DETAILED DESCRIPTION OF PREFERRED EMBODIMENTS

The emergency lighting systems and devices with projected directional indication disclosed herein are subject to varied embodiments. However, to ensure that one skilled in the art will be able to understand and, in appropriate cases, practice the present invention, certain preferred embodiments of the broader invention revealed herein are described below and shown in the accompanying drawing figures.

With this in mind and looking more particularly to the accompanying drawings, certain exemplary embodiments of the emergency lighting device disclosed herein are indicated generally at 10 in the drawings. The emergency light 10 can be considered to be founded on a housing 12. The housing 12 in this example is generally rectangular in cross section with a boxlike open inner volume. The open inner volume of the housing 12 is defined by a first end wall 18, a second end wall 20, a first sidewall 14, a second sidewall 16, and a bottom wall 22.

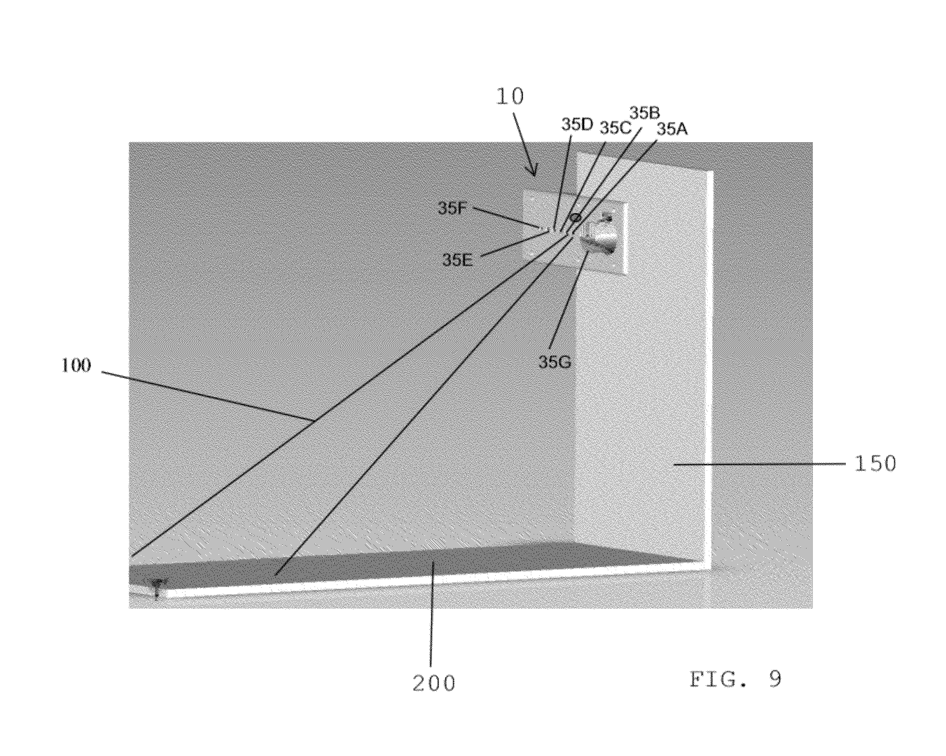

First and second flanges 24 can extend from the first and second end walls 18 and 20 respectively for enabling a mounting of the emergency light 10 relative to a support surface 150 as suggested by FIG. 9. The flanges 24 permit a recessed mounting of the emergency light 10, but it will be appreciated that the emergency light 10 could readily be surface mounted or retained by an AC wall plug as described further hereinbelow.

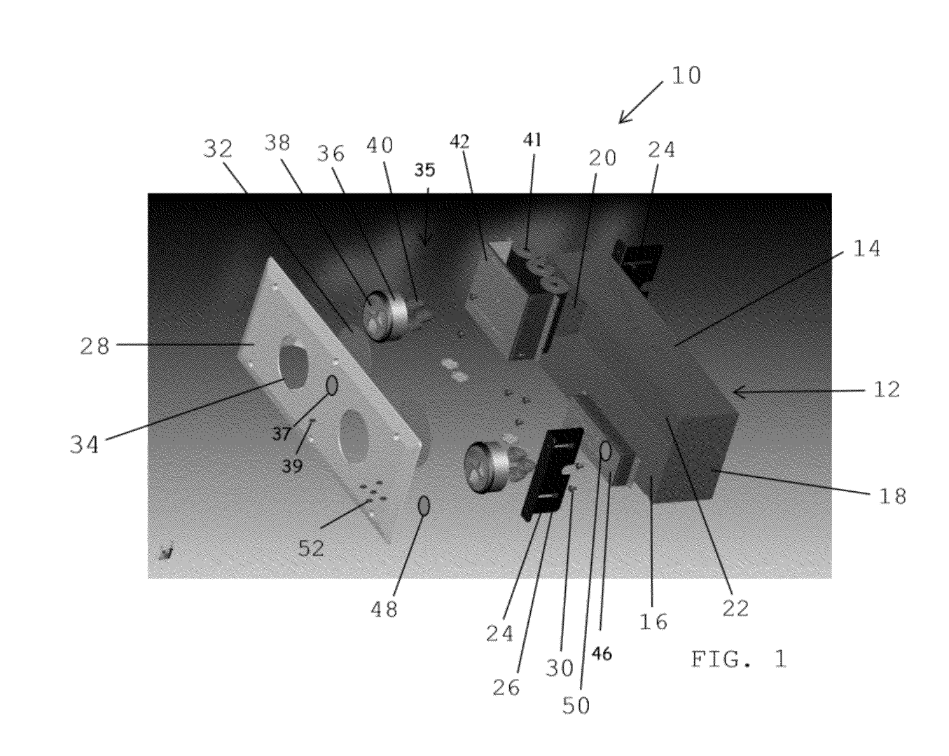

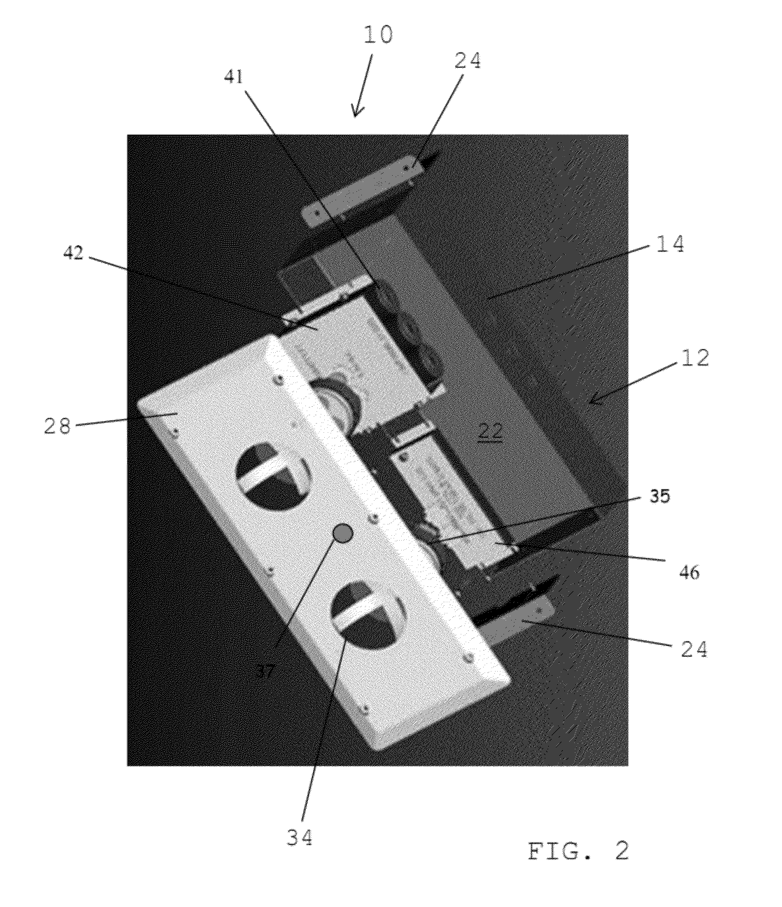

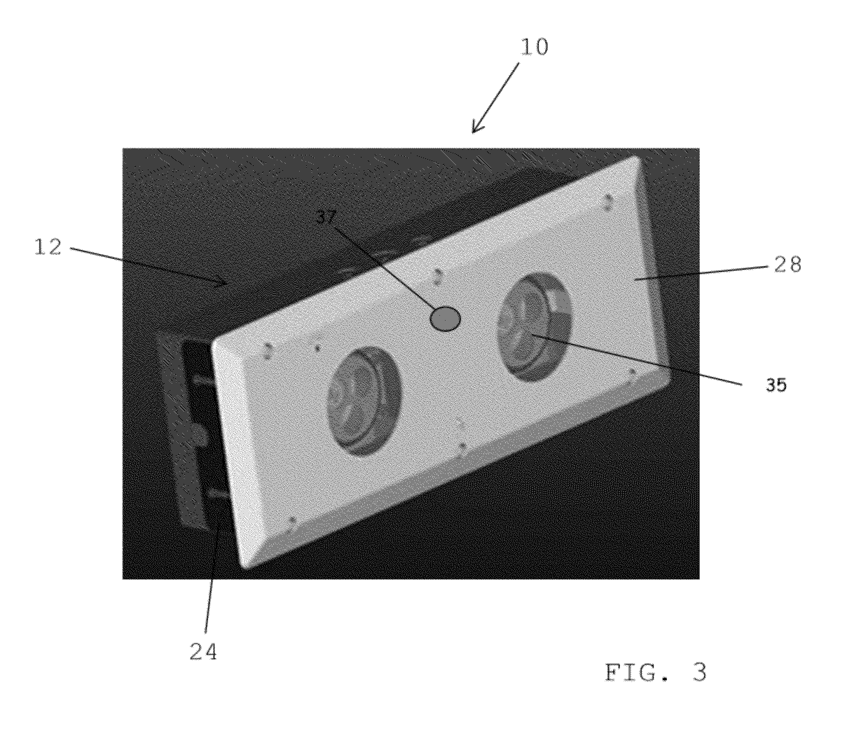

The first and second flanges 24 can be integrally formed with the housing 12. Alternatively, the flanges 24 can be fixed to the first and second end walls 18 and 20 by any effective means. For example, as is shown in FIG. 1, the first and second flanges 24 can be removably coupled to the first and second end walls 18 and 20 by a fastening means, such as threaded fasteners 26. With this, the emergency light 10 can be retained relative to a support surface 150 as shown in FIG. 9 relying at least in part on the flanges 24 as in what is commonly referred to as an old work situation. Alternatively, where the framing of a support surface 150 is exposed as in a new work situation, the housing 12 of the emergency light 10 can be fixed directly to the framing, likely with the flanges 24 entirely removed.

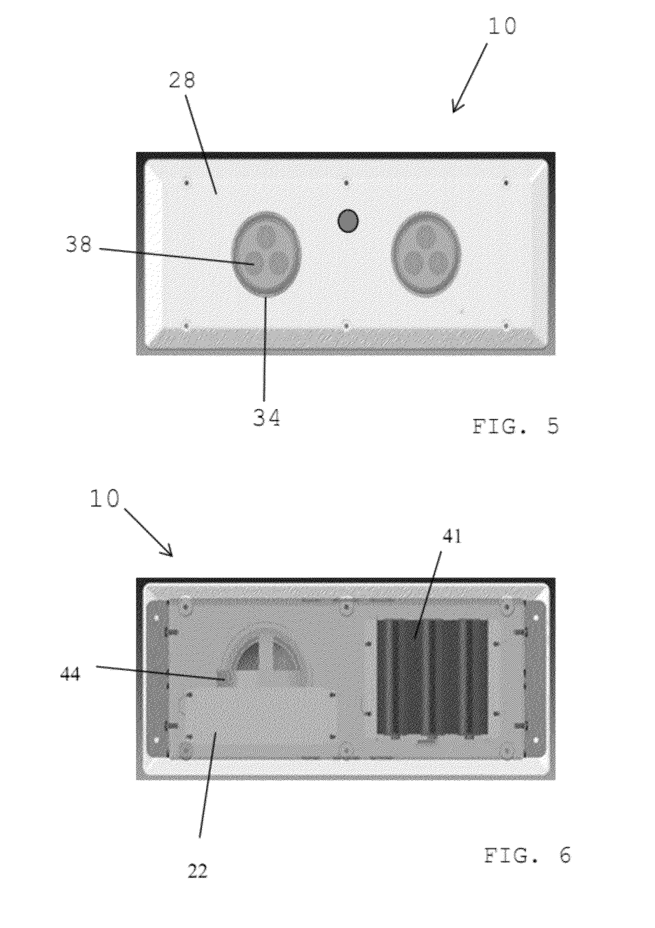

The support surface 150 can comprise a wall surface, a ceiling surface, or any other possible support surface. A cover plate 28 can overlie the housing 12 to substantially enclose the open inner volume thereof. Fasteners 30 can secure the cover plate 28 to the housing 12 as shown in FIG. 5. The same fasteners 30 could be employed to retain the housing 12 and the emergency light 10 in general relative to the support surface 150 in a substantially flush relationship.

Under this arrangement, the emergency light 10 can be secured in relation to a portion of a wall or ceiling or other support surface 150 by first inserting the housing 12 into the support surface 150. Then, fasteners 30 can be employed to secure the flanges 24 to the wall or other support surface 150. The cover plate 28 can then be secured over the housing by fasteners 30 being screwed through the plate 28 and into the flanges 24, the housing 12, and, additionally or alternatively, the support surface 150. With this, the emergency light 10 will be secured in place.

When mounted with the housing 12 inserted into the support surface 150, the emergency light 10 is substantially flush with and concealed relative to the support surface 150. The housing 12 can be mounted in a freestanding position in a wall or ceiling support surface 150, or it can be secured directly to framing (not shown) within the wall or ceiling support surface 150. The housing 12, the cover plate 28, and each of the other parts of the emergency light 10 can be crafted from any suitable material within the scope of the present invention, including metal, plastic, or any suitable composite material.

The cover plate 28 has one or more lens apertures 34 therein. In the depicted embodiment, there are first and second lens apertures 34. It will be understood, however, that fewer or more apertures 34 might be provided except as the invention might be expressly limited. Lens covers 32 are retained to the proximal sides of the lens apertures 34 directly under the cover plate 28 thereby shielding the lens apertures 34.

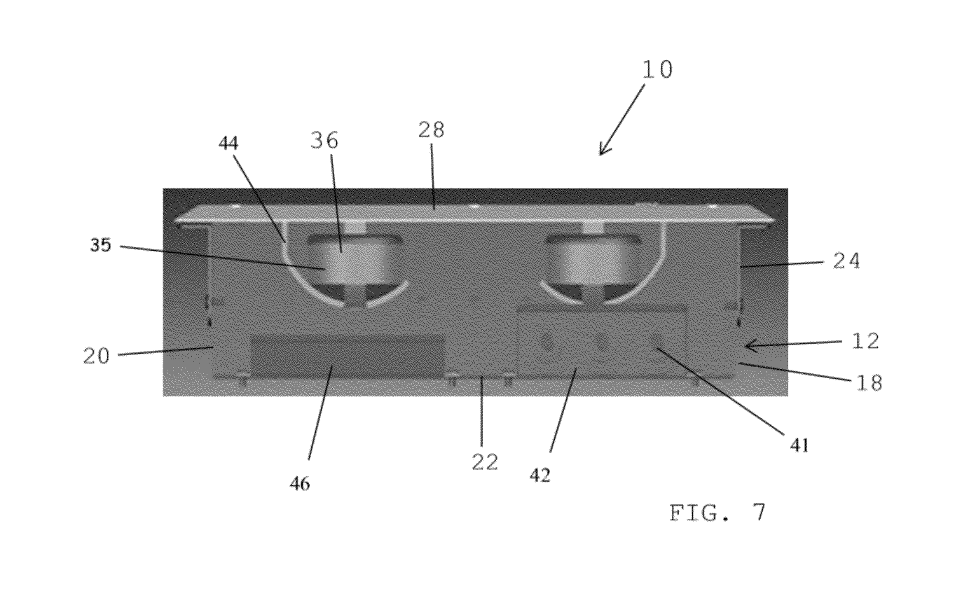

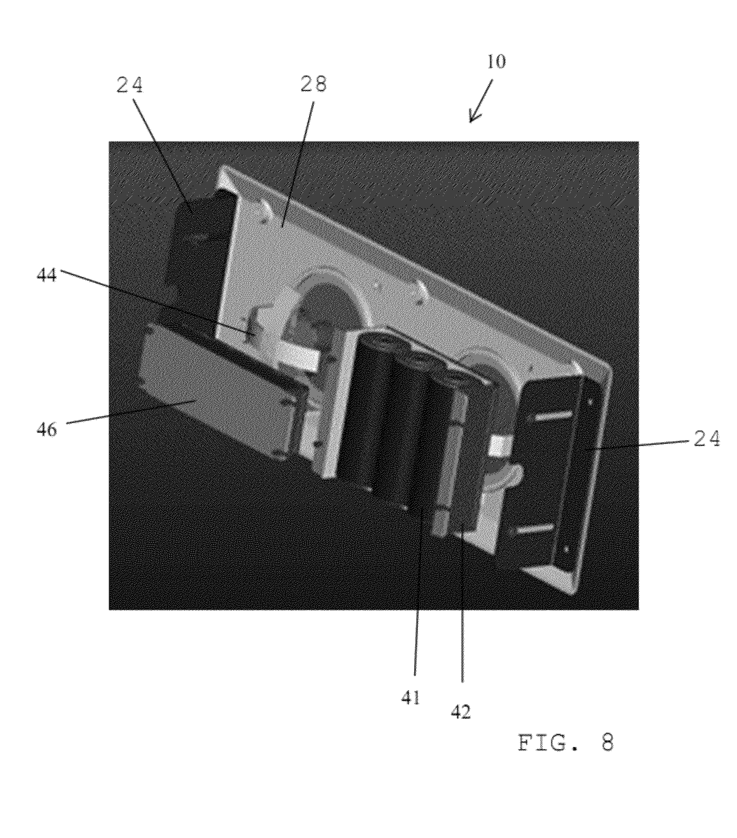

A light source 35 is retained relative to each lens aperture 34 by a bracket 44 as best seen perhaps in FIG. 7. With that, the light sources 35 can emit light from the respective lens apertures 34, whether individually, in unison, or otherwise as described further hereinbelow. Again looking to FIG. 1, the light sources 35 in the present embodiment are founded on a lens base 36. Each lens base 36 retains lenses 38 by a threaded engagement therebetween. The lenses 38 are translucent or transparent and may be optically clear or may have a given magnification or other optical characteristic. The depicted lenses 38 are generally annular, each with a proximal end retained by the lens base 36, a closed distal end, and an open inner volume. A lamp 40 with a bulb and socket is disposed within the open inner volume of each lens 38.

The light sources 35 can utilize a wide variety of lamps 40. In certain embodiments, each lamp 40 can comprise a laser lighting arrangement, a small bi-pin lamp, such as an LED, a halogen lamp, an incandescent lamp, a strobe-type flashing lamp, or any other effective lamp arrangement. The lenses 38 can be constructed of plastic, glass, or any other suitable material. In certain embodiments, the lenses 38 can be provided with emergency arrows, emergency insignias, or the like for safe egress as is also described hereinbelow.

Numerous conditions for activating the emergency lighting device 10 are possible within the scope of the invention. In one example where alternating current power is normally received through building current, a circuit board 46 can sense an activating condition in the form of an absence of alternating current, which would be indicative of a power failure. The circuit board 46 can switch to backup batteries 41 in response to the loss of alternating current. The backup batteries 41 can be retained in relation to the housing 12 by a retaining casing 42, which can be crafted from plastic or the like. The circuit board 46 or other means can send illuminating power through wiring or otherwise to the light sources 35 in response to a sensed condition, which may be an emergency or other predetermined activation condition. The circuit board 46 or another means can sense a termination of the activating condition, such as the restoration of alternating current, to terminate power flow to the light source 35.

The emergency light 10 could be constructed such that other activating conditions could induce an activation of the light sources 35. For example, the emergency lighting device 10 can be activated in response to a sensed alarm condition within a building structure. As described further hereinbelow, numerous alarm conditions are certainly possible including a fire alarm signal, a carbon monoxide alarm signal, a security alarm signal, or any other alarm signal. The emergency light 10 can incorporate a sensor 37, which can be a smoke detecting sensor, a carbon monoxide sensor, or any other type of sensor.

The emergency lighting device 10 can incorporate an indicator light 39 as shown in FIG. 1. The indicator light 39 can provide an indication of proper functioning of the emergency lighting device 10, such as by being continuously on or by blinking, and a lack of proper function of the emergency light 10, such as a loss in power either in the backup batteries 41 or from a source of alternating current. While a separate button (not shown) could be provided, the indicator light 39 can additionally serve as a test button to enable a periodic testing of the capabilities of the emergency lighting device 10.

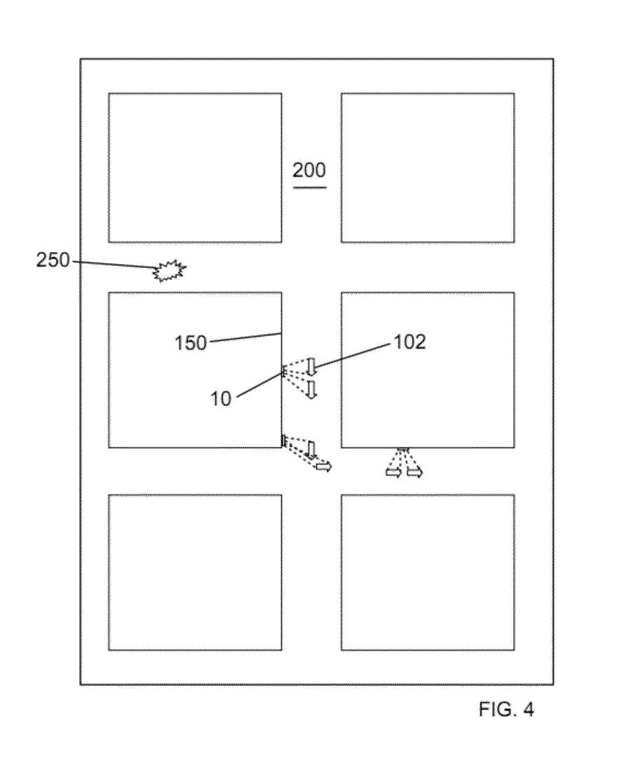

The emergency lighting device 10 can thus be mounted in relation to a wall, a ceiling, or any other support surface 150 as illustrated in FIG. 9. In the event of a power failure, alarm condition, or other activating condition, the light sources 35 can then be illuminated either by power from the backup batteries 41 or from a source of alternating current. When activated, the light sources 35 project a beam 100, such as a laser beam, as seen in FIG. 9 to produce a directional guidance indication 102, such as an arrow, as seen in FIGS. 4 and 9.

In this example, the projected guidance indication 102 is in the form of an arrow, which would be aimed to guide a building occupant toward safety, such as egress from a building structure. Of course, innumerable projected guidance indications 102 are possible within the scope of the invention. For example, series of arrows could be projected either simultaneously or in progression. Furthermore, indications 102 of different colors could have different meanings, either to all occupants or to particular occupants. Indications 102 could be condition dependent or fixed in form.

As seen in FIG. 4, for example, a plurality of emergency lighting devices 10 are mounted to wall structures 150 within the hallways of a building. The emergency lighting devices 10 can cooperate under centralized control to guide a building occupant away from a hazard 250, such as a fire, hostile building occupant(s), or another hazard 250 by a selective activation of the lighting devices 10 and a selective orientation of the guidance indications 102, in this case arrows, provided thereby. In the depicted example, each lighting device 10 projects two arrows 102. The orientation and, potentially, the color or other characteristic of the directional indications 102 could be varied depending on the type and location of the hazard 250 or other emergency situation.

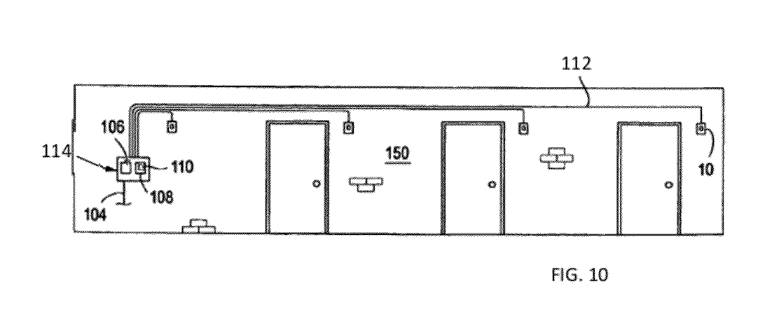

It will again be noted that fewer or more than two light sources 35 could be employed. In the embodiment of FIG. 9, for example, the emergency lighting device 10 has first through sixth projected guidance indication light sources 35A through 35F in addition to an illumination light source 35G, which in this embodiment is extendable and retractable. The illumination light source 35G can simply provide illumination to the surrounding area without necessarily including any particular guidance indication. The projected guidance indication light sources 35A through 35B can be individually and selectively activated to provide particularized guidance to building occupants. For example, light sources 35A through 35C could project guidance indications 102 comprising arrows pointed sequentially in a first direction, and light sources 35D through 35F could project guidance indications 102 comprising arrows pointed sequentially in a second, opposite direction. With this, a building occupant can be selectively directed toward safe egress and, potentially, away from danger. Multiple lighting devices 10 as in FIGS. 4 and 10 could cooperate to establish a safe evacuation route and, additionally or alternatively, to direct a person away from a hazard.

It would also be possible for each light source 35 to have multiple, selectively activated lamps 40 of different colors or for multiple light sources 35A through 35B to project indications having different colors. With that, a lighting device 10 can, among other things, provide an indication of a threat level, such as with green, yellow, and red indicating progressive threat levels. Alternatively or additionally, each light source 35 or multiple different guidance indication light sources 35A through 35G can project different indications, which may or may not be directional.

In certain practices of the invention, an emergency lighting arrangement employing a plurality of emergency lights 10 can be created in relation to a building structure as shown in FIG. 10. Emergency lights 10 could be disposed throughout a building where necessary or desirable in relation to ceiling and other support surfaces 150. The emergency lights 10 could be operably associated with a central control unit 114, whether by wired or wireless connections. The emergency lights 10 can be electrically associated with one another and the central control unit 114 by unit wiring 112, which can transmit power and control and alarm signals therebetween. Central wiring 104 can provide power to the system created by the central control unit 114 and the multiple emergency lights 10. A backup battery 106 could be incorporated into the central control unit 114 for providing emergency power to the emergency lights 10 through the unit wiring 112 through the central wiring 104 when alternating current is unavailable.

A central control circuit 110 can be provided on a central circuit board 108 of the central control unit 114. Under such arrangements, control signals could be provided to all emergency lights 10 through the central circuit board 108. Where the emergency lights 10 receive electrical power from the central control unit 114 or another central source, the backup batteries 41 could be foregone from the individual emergency lights 10 thereby enabling a simpler and more compact construction thereof and a reduction in necessary maintenance. Alternatively, the individual emergency lights 10 could provide redundant capabilities.

Additionally or alternatively, wireless communication means can enable control and communication between the central control unit 114 and the emergency lights 10. The central wiring 104 could nonetheless provide power and possibly communication to and between the central control unit and the emergency lights 10. By these connections, the central control unit 114 can transmit signals to the emergency lights 10 to trigger activation. The central control unit 114 may receive its signal from another source, such as an alarm system, a separate emergency control panel, or another system for sensing an emergency condition located in the building or elsewhere. When an emergency has ceased, the central control unit 114 can, if necessary, transmit a deactivation signal to the emergency lights 10.

As shown in FIG. 1, the emergency light 10 can have a microphone 48 incorporated therein in electrical communication with the remainder of the light 10, such as through the circuit board 46, and to a sound operated switch, which could be incorporated into the circuit board 46. The microphone 48 can be disposed within the housing 12 and can receive acoustic input through apertures 52 in the cover plate 28. The circuit board 46 can interconnect the microphone 48 with a potentiometer 50, which can be disposed on the board 46 and a relay. With this, the light sources 35 can be activated in response to an acoustic input received by the microphone 48, such as the sound emitted from a smoke, fire, security, flood, emergency, or other alarm device.

Under certain practices of the invention, the system can automatically interrupt external power to the emergency light 10 in response to an acoustic input, electronic signal, or other signal indicative of an emergency condition through an electronic or other signal intercepted or otherwise transmitted from an emergency alarm system, and, additionally or alternatively, from a building emergency control panel (not shown). It will be appreciated that the signals can be transmitted by wire, wirelessly, or by a combination thereof through communication with the emergency control panel, which could for example comprise a fire control panel or building alarm panel, and communication, such as through a relay, from the same wired or wireless connection to the AC power supply powering the emergency light 10.

Under such an arrangement, the intercepted signal from the emergency control panel during a detection of a dangerous emergency situation, such as fire or carbon monoxide detection, explosion detection, airborne contaminant detection, or radiologic detection, triggers a termination of AC power to the emergency lights 10. An emergency light 10 can be activated to operate under battery power based on that termination of power or otherwise. The light sources 35 can be deactivated in response to a cessation of the emergency condition, such as the cessation of the alarm sound or the alarm signal. Upon cessation of the emergency situation where a deactivation signal is transmitted between the emergency control panel and the audio and/or visual alarm devices, the same wired or wireless connection can receive the deactivation signal. A cessation in the alarm signal and/or the alarm sound can correlate to a signal of a cessation of the security, emergency, or other condition. The relay can automatically permit the resumption of external power to the emergency light 10 whereupon the light sources 35 will be extinguished. When system power is restored, the batteries 41 can be automatically recharged for future use.

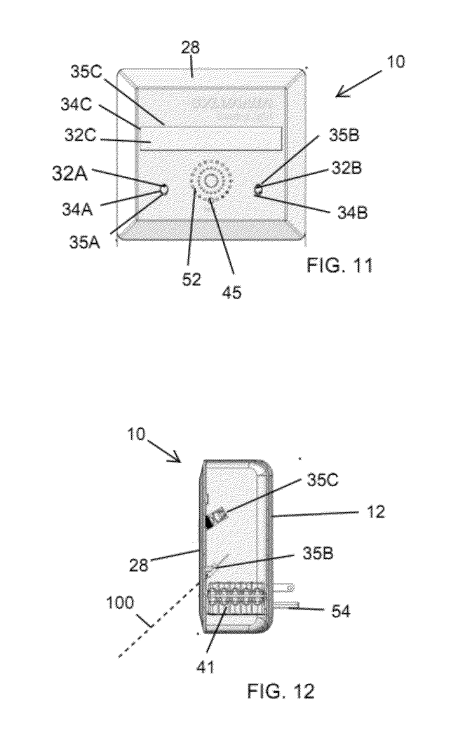

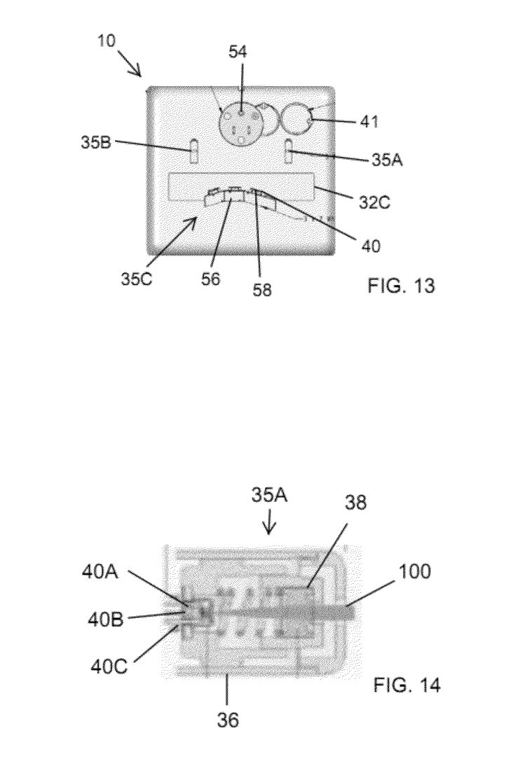

Further embodiments and details can be understood by additional reference to FIGS. 11-16. Looking first to FIGS. 11-13, the depicted emergency lighting device 10 has a first guidance indication light source 35A, a second guidance indication light source 35B, and an illumination light source 35C. The illumination light source 35C provides general illumination to the area surrounding the lighting device 10. The first guidance indication light source 35A can project a first guidance indication, such as a directional arrow in a first direction, and the second guidance indication light source 35B can project a second guidance indication, such as a directional arrow in a second direction opposite the first. As shown in relation to the second guidance indication light source 35B in FIG. 12, each of the guidance indication light sources 35A and 35B has a downward orientation such that the beam 100 emitted thereby will be projected downwardly, such as onto a floor surface, to produce a guidance indication, such as an arrow 102 as shown in FIG. 4 and elsewhere. Under this construction, the first guidance indication light source 35A could be activated to direct an occupant in the first direction and toward safety, or the second guidance indication light source 35B could be actuated to direct the occupant in the second direction toward safety where that direction is preferable to the first direction.

The illumination light source 35C has first, second, and third lamps 40, each with a reflector 58, mounted on a base member 56. Each lamp 40 could, for example, comprise an LED or any other light source. The base member 56 in this example has a plurality of sections, each retaining a lamp 40, that can be adjusted in orientation relative to one another such that the angular range of illumination can be adjusted at least to a certain extent. The lamps 40 are disposed behind a slot-like opening 34C that is sealed by a translucent or transparent panel cover 32C. As seen in FIG. 12, the illumination light source 35C is mounted relative to the housing 12 at an orientation with a downward angle whereby light will be generally directed downwardly, such as toward a floor surface. With that, illumination of the lamps 40 will induce light to be emitted in a primarily downward orientation from the opening 34C to illuminate the general floor area surrounding the lighting device 10.

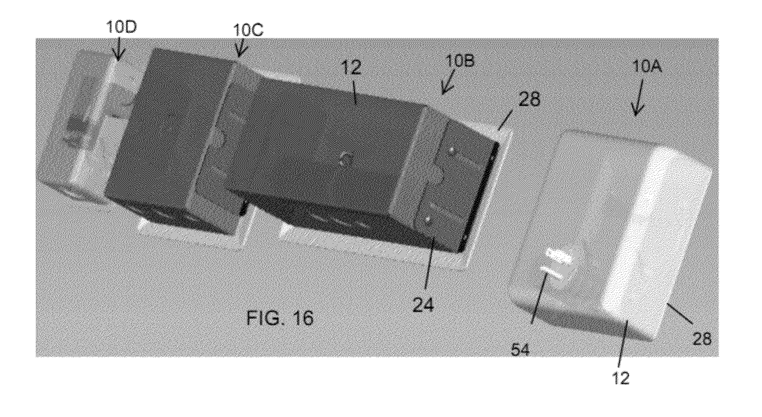

The lighting device 10 could again receive power from a wired connection as described previously and as shown in relation to the illumination devices 10B, 10C, and 10D shown in FIGS. 15 and 16. Alternatively, as shown in relation to the illumination device 10 in FIGS. 11 through 13 and the illumination device indicated at 10A in FIGS. 15 and 16, it is also contemplated that the illumination device 10 could receive AC power by being plugged into a wall or other outlet by use of a plug 54. In either case, the illumination device 10 can again have backup batteries 41, which can be rechargeable or disposable.

As shown in FIG. 11, the illumination devices 10 can have a test button 45 to verify the proper operation of the device 10. The cover plate 28 has a plurality of speaker apertures 52 therein for enabling the device 10 to, among other things, emit emergency notifications. It is contemplated that the speaker 48 (shown in FIG. 1) could be used to carry out an intercom function to enable guidance to the building occupant and, potentially, communication by the building occupant to rescue personnel and other persons. Still further, the lighting device 10 can employ the test button 45 or another means for enabling a recordation of a custom message and means for causing the custom message to be played during an emergency situation. For example, a custom message could give guidance based on the particular location of the lighting device 10 and, additionally or alternatively, in relation to particular building occupants or other particularities. For example, a parent could use the recordation function to guide a child from his room to safe egress from a home with reduced panic, a building owner could give an explanation of a preferable evacuation route from a specific location, or some other detailed message could be recorded.

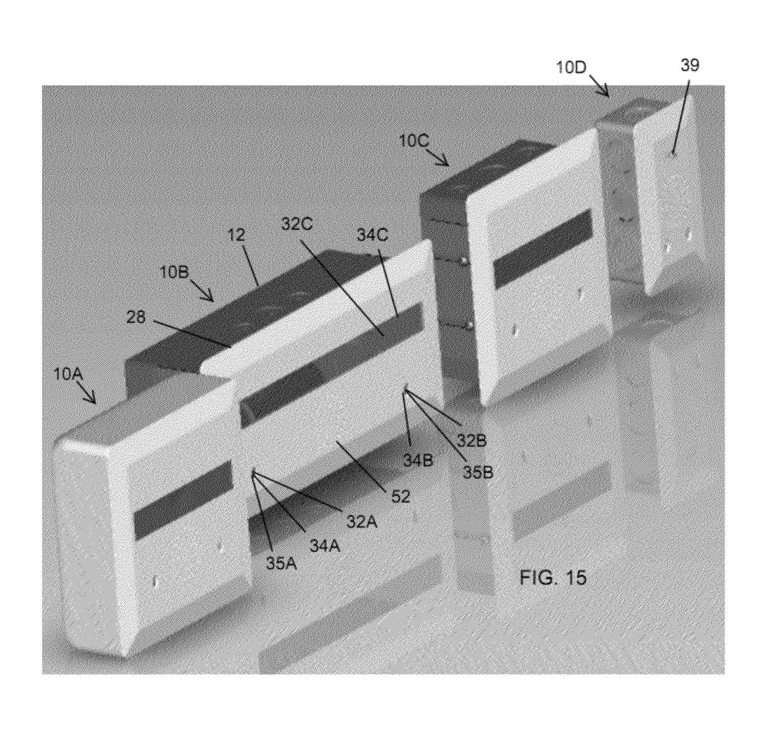

The first and second guidance indication light sources 35A and 35B can be of any type that is capable of projecting or being caused to project a directional indication 102, whether it be an arrow as illustrated, a chevron, or some other indication that provides directional guidance to an observer. Each such directional indication should be considered to be within the scope of the invention except as it might be expressly limited. In one present embodiment, the guidance indication light sources 35A and 35B comprise laser light sources with a collimating lens 38 for producing a clear, controllable beam 100 as shown in relation to the first guidance indication light source 35A in FIG. 14 and a clear, controllable directional indication 102 resulting therefrom as shown, for example, in FIG. 4. It is possible that just one color light source could be employed to good advantage. However, as is also shown in FIG. 4, it is additionally contemplated to have differently colored lamps 40A, 40B, and 40C that can be separately or simultaneously actuated to achieve enhanced guidance. Here, first, second, and third lamps 40A, 40B, and 40C are provided for emitting different colors, such as green, yellow, and red respectively. As used herein, the term lamp shall be given its broadest interpretation and, except as it might be limited in the claims, shall be interpreted to include any structure capable of emitting light. Under this configuration, the first light source 40A could be actuated to indicate a low-level threat, and the second and third light sources 40B and 40C could be actuated to indicate mid-level and high-level threats respectively.

It will be appreciated that lighting devices 10 according to the invention could pursue a wide variety of configurations and mounting methods within the scope of the invention. For example, the plug-type lighting device 10A of FIGS. 15 and 16 could effectively be surface mounted by an insertion into a wall plug (not shown). Where additional or larger components and functions are to be incorporated, a larger, rectangular lighting device 10B could be provided as compared to the generally square configuration of the lighting device 10C. Finally, where certain functions are to be provided externally, such as where traditional emergency lighting is already considered satisfactory, an emergency light 10D of reduced size could be employed that does not have an illumination light source.

With certain details of the present invention for emergency lighting systems and devices with projected directional indication disclosed, it will be appreciated by one skilled in the art that changes and additions could be made thereto without deviating from the spirit or scope of the invention. This is particularly true when one bears in mind that the presently preferred embodiments merely exemplify the broader invention revealed herein. Accordingly, it will be clear that those with certain major features of the invention in mind could craft embodiments that incorporate those major features while not incorporating all of the features included in the preferred embodiments.

Therefore, the following claims are intended to define the scope of protection to be afforded to the inventor. Those claims shall be deemed to include equivalent constructions insofar as they do not depart from the spirit and scope of the invention. It must be further noted that a plurality of the following claims may express certain elements as means for performing a specific function, at times without the recital of structure or material. As the law demands, these claims shall be construed to cover not only the corresponding structure and material expressly described in this specification but also all equivalents thereof that might be now known or hereafter discovered.

1. An emergency lighting device for providing a directional indication on a recipient surface, the emergency lighting device comprising:
a housing with an open inner volume;
a guidance indication light source retained relative to the housing;
means for selectively illuminating the light source to emit a beam of light; and
means for causing the beam of light emitted by the light source to achieve a directional indication;
whereby the directional indication can be provided on a recipient surface by an illumination of the light source.

2. The emergency lighting device of claim 1 wherein the directional indication of the guidance indication light source points in a first direction.

3. The emergency lighting device of claim 2 further comprising a second guidance indication light source retained relative to the housing, means for selectively illuminating the second light source to emit a beam of light, and means for causing the beam of light emitted by the second light source to achieve a directional indication.

4. The emergency lighting device of claim 3 wherein the directional indication of the second guidance indication light source points in a second direction different than the first direction.

5. The emergency lighting device of claim 3 wherein the first and second guidance indication light sources are individually operable.

6. The emergency lighting device of claim 2 wherein the directional indication comprises an arrow.

7. The emergency lighting device of claim 1 wherein the means for causing the beam of light emitted by the light source to achieve a directional indication comprises a collimating lens.

8. The emergency lighting device of claim 1 wherein the light source comprises a laser.

9. The emergency lighting device of claim 1 further comprising an illumination light source for illuminating an area adjacent to the emergency lighting device.

10. The emergency lighting device of claim 9 wherein the illumination light source does not provide guidance indication.

11. The emergency lighting device of claim 1 further comprising means for selectively emitting illumination in at least a first color and a second color.

12. The emergency lighting device of claim 11 wherein the means for selectively emitting illumination in at least the first color and the second color comprises the guidance indication light source for emitting light in the first color and a second guidance indication light source for emitting light in the second color with means for selectively illuminating the light source to emit a beam of light and means for causing the beam of light emitted by the second light source to achieve a directional indication.

13. The emergency lighting device of claim 12 wherein the directional indications of the guidance indication light source and the second guidance indication light source point in the same direction.

14. The emergency lighting device of claim 11 wherein the means for selectively emitting illumination in at least the first color and the second color comprises first and second lamps of the guidance indication light source whereby the directional indication provided by the guidance indication light source can be selectively emitted in the first color or the second color.

15. The emergency lighting device of claim 11 wherein the means for selectively emitting illumination in at least the first color and the second color comprises first and second lamps of the guidance indication light source.

16. The emergency lighting device of claim 11 wherein the first and second lamps comprise lasers.

17. The emergency lighting device of claim 1 wherein the housing has an upper side and a lower side and wherein the beam of light is angled toward the lower side of the housing whereby the beam of light emitted by the light source can provide a directional indication on a surface below the emergency lighting device.

18. The emergency lighting device of claim 1 further comprising a means for enabling a recordation of a custom message and means for causing the custom message to be played during an emergency situation.

19. A system of emergency lighting devices for guiding a building occupant by providing directional indications on recipient surfaces, the system of emergency lighting device comprising:
a plurality of emergency lighting devices wherein each emergency lighting device comprises:
a housing with an open inner volume;
a guidance indication light source retained relative to the housing;
means for selectively illuminating the light source to emit a beam of light; and
means for causing the beam of light emitted by the light source to achieve a directional indication;
whereby the directional indication can be provided on a recipient surface by an illumination of each light source;
means for providing centralized control to the plurality of emergency lighting devices whereby the emergency lighting devices can cooperate to guide a building occupant.

20. The system of emergency lighting devices of claim 19 wherein the directional indication of the guidance indication light source of each emergency lighting device points in a first direction and further comprising a second guidance indication light source retained relative to the housing of each lighting device, means for selectively illuminating the second light source to emit a beam of light, and means for causing the beam of light emitted by the second light source to achieve a directional indication in a second direction different than the first direction.

21. The system of emergency lighting device of claim 20 wherein the first and second guidance indication light sources are individually operable.

22. The system of emergency lighting device of claim 19 further comprising means for selectively emitting illumination in at least a first color and a second color.
